(19) United States
(12) Patent Application Publication
(10) Pub. No.: US 2008/0267105 A1
(43) Pub. Date: Oct. 30, 2008

(54) ACTIVE MODE DISCONTINUOUS RECEPTION SYNCHRONIZATION AND RESYNCHRONIZATION OPERATION

(75) Inventors: Peter S. Wang, E. Setauket, NY (US); Jin Wang, Central Islip, NY (US); Stephen E. Terry, Northport, NY (US); Mohammed Sammour, Montreal (CA); Shankar Somasundaram, Deer Park, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/110,436

(22) Filed: Apr. 28, 2008

Related U.S. Application Data
(60) Provisional application No. 60/914,459, filed on Apr. 27, 2007.

(51) Int. Cl. G08C 17/00

(52) U.S. Cl. 370/311

(57) ABSTRACT

A method and apparatus for active mode discontinuous reception (DRX) synchronization and resynchronization operation are disclosed. A first entity sends a DRX indicator to a second entity. The first and second entities synchronize and resynchronize DRX operation based on the DRX indicator.

### CROSS REFERENCE TO RELATED APPLICATIONS

This application claims the benefit of U.S. provisional application No. 60/914,459, filed on Apr. 27, 2007, which is incorporated by reference as if fully set forth.

### FIELD OF INVENTION

This application is related to wireless communications.

### BACKGROUND

Current effort for the third generation partnership project (3GPP) long term evolution (LTE) program is to bring new technology, new architecture and new methods in the new LTE settings and configurations in order to provide improved spectral efficiency, reduced latency, better utilizing the radio resource to bring faster user experiences and richer applications and services with less cost.

In order to bring the power saving advantage to the LTE handsets, discontinuous transmission (DTX) and discontinuous reception (DRX) mode of operations are proposed to the LTE system and the handsets when the LTE handsets are in the LTE_Active mode. LTE system and the handsets will alternately perform the sleep action to save power and the wake-up action for monitoring the control signaling to see if there is data transmission/reception operation to be executed next.

The current state of LTE technology over the LTE_Active DRX operation lacks deterministic synchronization mechanisms. Transmission or decoding errors for explicit DRX signaling, timer error and hardware/software execution errors for implicit DRX configuration rules may result in loss of DRX and/or DTX synchronization between transmitter and receiver.

Once the DRX or DTX cycle is out of synchronization due to misalignment in time or other factors, DRX commands or indications from the sender (in both uplink and downlink directions) will not be heard or even listened to by the receiver. Accordingly, further data transmission/reception and other cooperated actions are not possible. Current LTE technology has also not defined any loss of synchronization detection and resynchronization schemes to recover from the possible DRX out-of-sync situation.

When a LTE WTRU is configured by radio resource control (RRC) or medium access control (MAC) layer signaling to enter the LTE_Active DRX/DTX mode operation, the DRX/DTX cycle lengths (active/inactive periods) and phase reference (period start frame offset) for one or more DRX/DTX stages/levels are given. A WTRU and an evolved universal terrestrial radio access network (E-UTRAN), (i.e., evolved Node-B (eNode-B)) execute the same DRX/DTX schedule, such that both the sender and receiver wake up at the same time (in the beginning of the cycle-period) to transmit or receive an signal in order to ascertain whether there is data for the receiver, and therefore, not to enter the sleep mode, but to receive and decode the data. FIG. 1 shows conventional layer 1/2 control channel signal for the DRX on and off.

During the DRX operations, both the WTRU and the E-UTRAN perform the same transition rules using defined explicit and/or implicit triggers to enable/disable and adjust the DRX cycle lengths. Due to various possible errors, transition triggers effecting the DRX cycle length and/or phase may result in de-synchronization of DRX/DTX periods between the transmitter and receiver. This causes the DRX de-synchronization, (i.e., the sender and the receiver may wake up at a different time (time or phase shifted), or sleep over a different cycle length (cycle length discrepancy)), such that explicit DRX/DTX configuration signaling timing is lost, or implicit DRX/DTX triggers are interpreted differently by the transmitter and receiver. De-synchronization may occur in either direction. Currently there are no mechanisms for DRX out-of-sync detection and recovery.

Therefore, there exists a need for a method and apparatus for detecting DRX de-synchronization.

### SUMMARY

A method and apparatus for active mode discontinuous reception (DRX) synchronization and resynchronization operation are disclosed. A first entity sends a DRX indicator to a second entity. The first and second entities synchronize and resynchronize DRX operation based on the DRX indicator.

### BRIEF DESCRIPTION OF THE DRAWINGS

A more detailed understanding may be had from the following description, given by way of example in conjunction with the accompanying drawings wherein:

FIG. 1 shows conventional layer 1/2 control channel signal/indicator for the DRX on and off;

FIG. 2 shows an example transmitter and receiver configured to implement the disclosed method for DRX synchronization and resynchronization;

FIG. 3 shows the recovery scheme for the DRX misalignment or de-synchronization in accordance with the present invention;

FIG. 4 shows another embodiment of the DRX recovery for de-synchronization in accordance with the present invention; and

FIG. 5 shows DRX resynchronization through RACH access in accordance with the present invention.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

A method and apparatus are disclosed for discontinuous reception (DRX) and/or discontinuous transmission (DTX) operation, synchronization and resynchronization, and detection and recovery of DTX/DRX between a transmitter and receiver.

FIG. 2 is a functional block diagram of a transmitter and receiver 110, 120 configured to perform the disclosed method. In addition to components included in a typical transmitter/receiver, i.e., a WTRU or Node-B, transmitter and receiver 110, 120 includes processors 115, 125 configured to perform the disclosed method of DRX synchronization, resynchronization and realignment, receivers 116, 126 in communication with processors 115, 125 transmitters 117, 127 in communication with processors 115, 125 and antenna 118, 128 in communication with receivers 116, 126 and transmitters 117, 127 to facilitate the transmission and reception of wireless data. Additionally, the receiver 116, transmitter 117 and antenna 118 may be a single receiver, transmitter and antenna, or may include a plurality of individual receivers, transmitters and antennas, respectively. Receiver 120 may be located at a WTRU or multiple transmitting circuits 120 may be located at a base station. Transmitter 110 may be located at either the WTRU, Node B, or both.

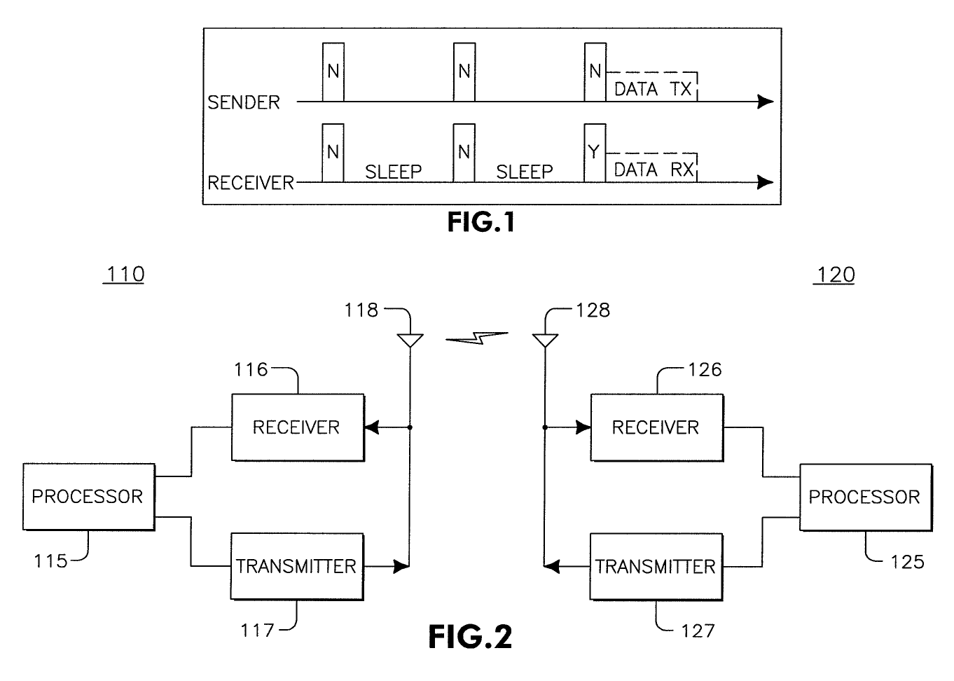

Again, FIG. 1 shows a prescribed DRX cycle. In accordance with a disclosed method, a DRX cycle includes a DRX-indicator that identifies the current DRX/DTX period and phase. The DRX-indicator may be signaled along with other signaling parameters such as downlink (DL) and uplink (UL) data transmission requests and scheduling information; periodic frame synchronization transmissions to support timing advance; channel quality measurement reporting; and any channel associated signaling.

In accordance with this method, the DRX-indicator includes DRX operation synchronization information, for example, a DRX/DTX period and phase indicator. The DRX/DTX period and phase indicator used for DRX/DTX period and phase detection includes at least one of a DRX/DTX period counter, a preconfigured DRX/DTX level index, current downlink wake-up frame number, and current inactivity timer value. For DTX/DRX period and phase recovery, the DRX operation synchronization information may also include at least one of an in-sync or out-of-sync indication, in one or both directions, a Sync-Request and Sync-Response, or Sync-Command (for resynchronization purpose), the current DRX level (or cycle length) with or without direction, a proposed next DRX cycle Level (or cycle length), and change time with or without direction, and a current downlink wake-up frame number and inactivity timer value.

Using the DRX/DTX indicators, out-of-sync conditions can be detected and recovered between the sender and the receiver, e.g., transmitter 110 and receiver 120. Both entities are also able to be sure they are synchronized with the correct DRX operation.

In order to keep the system from becoming overloaded, the DRX indicator(s) do not have to be sent in every DRX cycle. The periodicity can be relaxed depending on the running DRX cycle length, (i.e., the longer the DRX cycle length the tighter the periodicity in terms of cycles). For example, the DRX indicator may be sent with a periodicity of multiple cycles to reduce signaling overhead and overall cell interference. Similar to the DRX/DTX periods, the DRX indicator periodicity across multiple DRX periods may dynamically change based on explicit signaling and/or implicit triggering criteria. The DRX indicator can be sent during DRX on-duration or DRX active time through the physical downlink control channel (PDCCH) channel or medium access control packet data unit (MAC PDU).

Another method is disclosed wherein receiver 120 monitors the DRX indicator at the wake-up moments for an expected indicator value during DRX operation. Transmitter 110 and receiver 120 are configured to engage in this known pattern DRX synchronization. In accordance with this method, transmitter 110 includes the DRX indicator with a pattern value known to receiver 120. This pattern value may be a predetermined value, a bit pattern or bit combination.

This known pattern may be steady (i.e., the sender may indicate that it is “in-sync” and may also send the current DRX/DTX period and phase indicator) or varying (i.e., the sender may indicate that it is “in-sync” at a certain DRX level (DRX period)). Transmitter 110 may also send a value or bit-group that may be one of the following: a bit of alternate inverting values or known bit sequences such as the golden string bit values; a value following a known mathematical sequence such as a round-robin Fibonacci sequence numbers; or a simple sequence number counter that increments/decrements and wraps around.

If the DRX indicator is received at the right (wake up) time, and with the correct known indicator (steady values for the operational status such as the DRX period/phase indicator or a varying value following the known pattern), the DRX operation is confirmed to be synchronized. If an unexpected or no DRX indicator is received, a DRX out of sync event is detected.

Receiver 120, either in the uplink or downlink, monitors the DRX indicator to determine whether or not it is in-sync with transmitter 110. In accordance with the disclosed method, receiver 120 checks for the following sync types: a) the occurrence of the DRX indicator addressed to it at the expected time; and b) the expected values, or the known pattern, for the indicator value(s) carried by the DRX indicator.

When receiver 120 misses one or more DRX indications addressed to it, a DRX out of sync is detected (i.e., sync type (a)). Although an out of sync is detected each time it is missed, it is preferable that receiver 120 allow more misses when the DRX cycle is shorter depending on if the DRX cycle lengths are factored in or not. For example, if all the cycle lengths are factored in, then receiver 120 may wait more before detecting a DRX out of sync.

When receiver 120 has determined that the expected indicator value is not following the known value pattern or the value is not consistent with the DRX phase it expects, then a mismatch of the DRX level, i.e., sync type (b), (for example, the cycle length, wherein a DRX period problem is detected by receiver 120).

It should be noted that sync type (a) and (b) problems may occur at or near the same time period. In accordance with this disclosed method, receiver 120 performs a realignment action for sync type (a) problems and a resynchronization action for sync type (b) problems. As such, realignment and resynchronization actions can be performed together.

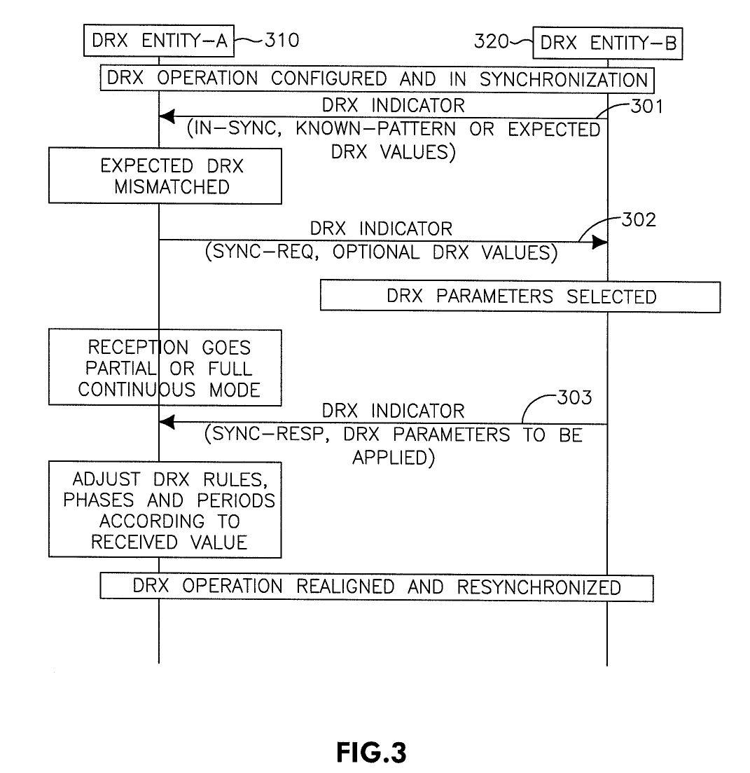

FIG. 3 shows a signal diagram of the disclosed method for recovery for a DRX misalignment or de-synchronization. It should be noted that the DRX-indicator shown in FIG. 3 may be a signal on a Layer 1/Layer 2 (L1/2) control signaling channel, e.g. PDCCH, or a MAC control element (CE) or radio resource control (RRC) message. Preferably the DRX indicator should be sent through PDCCH during DRX on duration.

Referring to the example shown in FIG. 3, according to the disclosed method, during DRX on duration, DRX Entity B 320 transmits a DRX Indicator 301 to DRX Entity-A 310. DRX Indicator 301 includes a pattern or value IN-SYNC indicator, that is known to DRX Entity-A 310 and DRX Entity-B 320. If DRX entity-A 310 does not receive the DRX Indicator 301, or the known value or pattern does not match the received DRX Indicator in the received DRX indicator, a DRX misalignment or a de-synchronization is detected, and a recovery procedure is performed.

Upon detection of a DRX misalignment or de-synchronization by DRX Entity-A 310, DRX-Entity-A 310 transmits a SYNC-REQ message included in a DRX Indicator 302. DRX parameters that DRX Entity-A 310 is currently executing may be included in the SYNC-REQ message to DRX Entity-B 320. DRX-Entity-A 310 then performs a “shorter cycle” method, a “capture” method, or a “partial or full continuous mode” reception method, in order to receive the next DRX indicator from DRX-Entity-B 320, each method to be discussed in further detail below.

Once DRX-Entity-B 320 receives the SYNC-REQ message 302 from DRX-Entity-A 310, the DRX-Entity-B, depending on the DRX-entity relationship, selects the DRX parameters to forward to DRX Entity-A 310 in response to the SYNC-REQ 302 using one of the following DRX-Parameter-Determination-Rules: 1) apply the current DRX parameters from DRX-Entity-A 310; 2) apply the current DRX parameters from (itself) DRX-Entity-B 320; 3) take the shorter DRX cycle length and the associated DRX parameters from the DRX parameters of the two entities; or 4) determine to reset one or both sides to continuous mode.

Once DRX-Entity-B 320 selects the DRX parameters, the DRX-Entity-B transmits a response, a SYNC-RESP message 303, which includes the determined DRX parameters to DRX-Entity-A 310. DRX Entity-A 310 then adjusts to the determined DRX parameters.

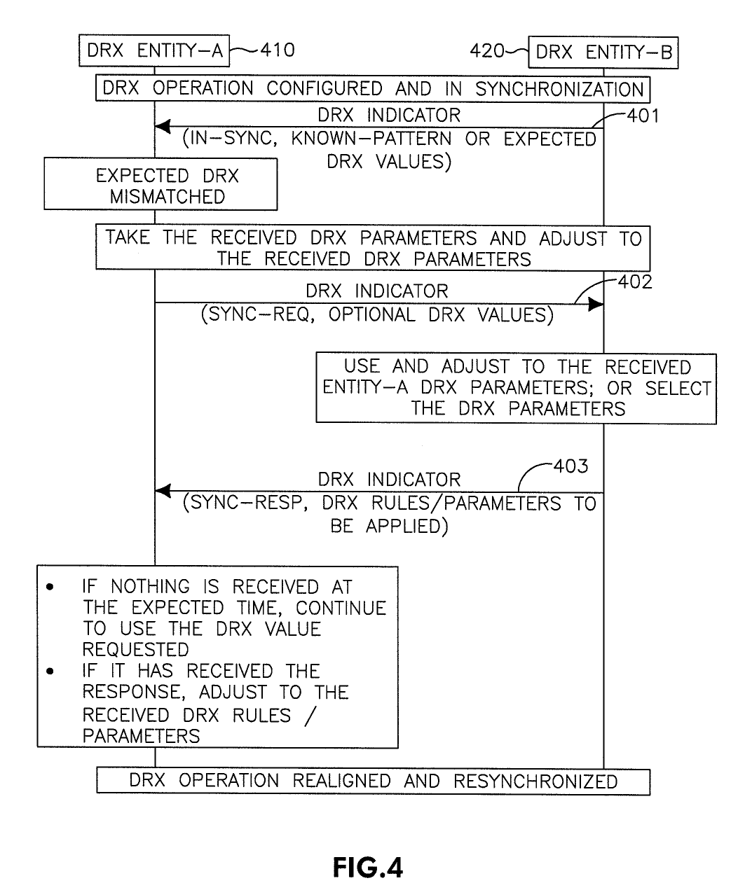

A disclosed method for DRX recovery for de-synchronization is shown in FIG. 4. In accordance with this method, DRX Entity B 420 transmits a DRX Indicator 401 to DRX Entity-A 410. DRX Indicator 401 includes a pattern or value IN-SYNC indicator that is known to DRX Entity-A 410 and DRX Entity-B 420. Once DRX-Entity-A 410 has detected that the received DRX expected value does not match, the DRX-Entity-A 410 may accept the DRX parameters from DRX-Entity-B 420 and reset itself to the DRX parameters that DRX-Entity-B 420 is currently executing. Alternatively, when DRX-Entity-A 410 has detected that the received DRX expected value does not match, DRX-Entity-A 410 may transmit a SYNC-REQ 402 message with the desired DRX parameters to the DRX-Entity-B 420.

In this alternative, DRX Entity-B 420 upon receipt of the desired DRX values may determine the appropriate DRX parameters to transmit to DRX-Entity-A 410 using the DRX-Parameter-Determination-Rule disclosed above, or uses the DRX parameters from DRX Entity-A 410 and adjusts to them and no more actions are taken by DRX-Entity-B 420.

If DRX-Entity-B 420 selects the parameters using the a DRX-Parameter-Determination-Rule, as indicated above DRX-Entity-B 420 selects the DRX parameters using one of the following: (1) uses DRX Entity-A's 410 parameters, (2) uses DRX-Entity-B's 420 parameters, (3) take the shorter DRX cycle length and associated parameters, or (4) reset to a continuous mode, and transmit the SYNC-RESP message with the determined DRX parameters to DRX-Entity-A 410.

If DRX-Entity-A 410 does not receive an indicator from DRX Entity-B 420 at the expected time, then DRX Entity-A 410 assumes the proposed DRX parameters transmitted to DRX-Entity-B 420 is accepted. If DRX-Entity-A 410 receives the SYNC-RESP message from DRX-Entity-B 420, DRX Entity-A 410 adjusts to the DRX parameters included in the SYNC-RESP 403.

As indicated above, each receiver and transmitter performs a recovery procedure once a DRX misalignment or de-synchronization is detected. A method for recapturing the DRX indication when the receiver is under a DRX long cycle operation is disclosed. In accordance with this method, the receiver can switch to a shorter, or to the shortest, DRX cycle occasions to capture the DRX indicator as long as the long cycle is a multiple of the chosen shorter/shortest DRX cycles (longer-cycle-length=2ⁿ× short_cycle_length), and the phase is the same (i.e. the DRX occasion frame=SFN mod long_cycle_length=SFN mod short_cycle_length). Alternatively, even if the transmitter/receiver DTX/DRX is not in phase, the receiver can adjust the phase (i.e. adjust the occasion frame offset for receiving) if the phase difference is known.

A method is disclosed for capturing the DRX indication on a slightly wider frame range. Referring back to FIG. 3, when a DRX timing misalignment has been detected by DRX Entity-A 310, DRX Entity-A 310 may perform the reception of the DRX indicator over a wider range of {−x1, +x2} frames, where x1 and x2 may, or may not, be equal. The selected frame range may include the originally scheduled reception frame number, if only a time shift is perceived as the misalignment cause, or some predicted interception frame number time, calculated based on the configured different DRX cycle lengths, when the inconsistency of cycle lengths is perceived as the misalignment cause.

If the DRX misalignment is caused by the time shift (e.g., a timer error or hardware/software error), then the expected DRX indicator may be received and the DRX realignment achieved with the adjustment of DRX Entity-A's 310 receive time, based on the current DRX phase information from DRX Entity-B's 320 in the captured DRX indicator.

Another method for trapping the DRX signal/indication with partial or full continuous mode receiving is disclosed. If the estimated DRX cycle length is small, (e.g., y frames), then a trap (i.e., a continuous reception) of (y+1) frames may suffice to receive the DRX indication, as long as the transmitter is still sending the DRX indication. In order to quickly resume the DRX alignment for a high-powered LTE WTRU and for a high quality of service (QoS) service connection, a WTRU may decide to continuously receive the DRX indicator until the DRX phase for adjustment is obtained.

In another disclosed method, a WTRU may obtain DRX Realignment through use of the random access channel (RACH). In accordance with this method, if a remediation of the DRX misalignment cannot be achieved by the above disclosed “shorter cycle”, “capture” or “trap” methods, or the remediation process would take a longer amount of time than a max-DRX-Resync-time (for example, a defined, specified or commonly considered time), the WTRU may resort to a RACH access to request the network, e.g., E-UTRAN, for the resynchronization/realignment of the desynchronized DRX operation.

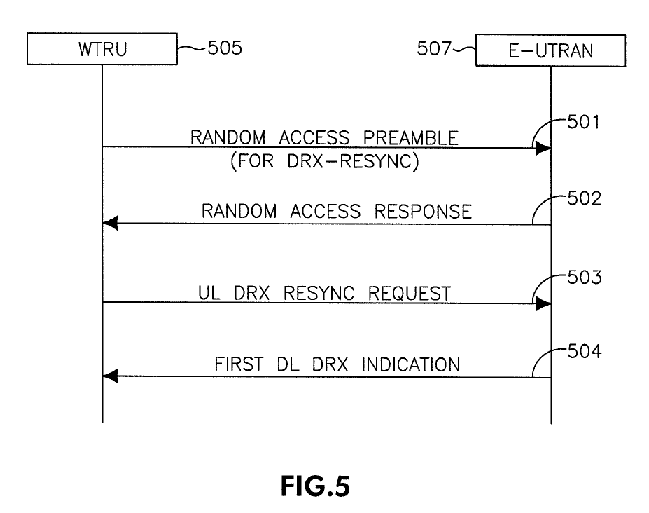

FIG. 5 shows an example of the disclosed method of DRX resynchronization through RACH access. In accordance with this method, the RACH access includes a special “Random ID” reserved for DRX resynchronization/realignment encoded in the initial access burst. WTRU 505 transmits a RACH access signal 501 including the Random ID for DRX Re-Synchronization to E-UTRAN 507. E-UTRAN 507, upon receiving RACH access request 501, performs the re-sync process via the L1/2 control signaling channel using a DRX-RESYNC-RNTI to specify the TA-alignment-info in a Random Access response message 502 the UL-Grant-info uses a L1/2 Control signaling channel for the third message below. WTRU 505 in a “UL DRX Resync Request” message 503 over UL L1/2 Control signaling channel, e.g. PUCCH, includes the WTRUs ID (C-RNTI or other) and the current DRX parameters to the E-UTRAN.

E-UTRAN 507 uses the DL L1/2 control signaling channel DRX indication 504 to start the DRX operation given one of those values, or E-UTRAN 507 may also have accumulated data to transmit, for which the “data available” can be used, or a MAC/RRC message to restart the DRX cycle.

A method to coordinate LTE DRX Resynchronization between the WTRU and the E-UTRAN is disclosed. At any time of the LTE_Active DRX operations, or after the WTRU or the E-UTRAN regain the steady reception of the DRX indicators after realignment, either the WTRU or the E-UTRAN may initiate the DRX cycle resynchronization to adjust the DRX to the appropriate or desired level through various ways of communication, (i.e., L1/2 control signaling or MAC or RRC signaling).

If the resynchronization is based on the system-user relationship, then the E-UTRAN will be the decider for the DRX cycle length. If the resynchronization is based on the peer-peer relationship, then peer's rule applies.

In addition to the DRX resynchronization, during anytime of the DRX operation, the E-UTRAN can command the WTRU to go to continuous mode operation, or to reconfigure the WTRU for a new DRX operation schedule through the signaling methods mentioned above. The Resynchronization determination process is the same as the DRX synchronization rules set forth above, including: 1) apply the current DRX rules/parameters from the Entity-A; 2) apply the current DRX rules/parameters from (itself) Entity-B; 3) take the shorter DRX cycle length and the associated DRX parameters from the DRX parameters of the two entities; or 4) determine to reset one or both sides to continuous mode.

The WTRU may send a Sync-Req indicator via the uplink control channel together with its current and requested DRX level (cycle length) to the E-UTRAN. The E-UTRAN responds with a Sync-Resp together with the indication on the grant or denial of the request.

The E-UTRAN can also command the WTRU to resynchronize to a certain DRX cycle length (DRX level). Regarding Resynchronization between the peers, either a shorter cycle or a longer cycle may take the precedence.

In the case where the shorter cycle takes the precedence, if the WTRU initiates the resynchronization via a Sync-Req, but the E-UTRAN wants a shorter DRX cycle, the E-UTRAN indicates the desired cycle length in the Sync-Resp and this length is to be used (the E-UTRAN otherwise uses a Sync-Resp with a Grant flag). If the E-UTRAN initiates the resynchronization via a Sync-Req, but the WTRU wants a shorter DRX cycle, the WTRU indicates the desired cycle length in the Sync-Resp and this length is to be used (the WTRU otherwise uses a Sync-Resp with a Grant flag).

In the case where the longer cycle takes the precedence, scenarios are about the same as described in the above except that the longer DRX cycle length takes the precedence. Note that the DRX phase shift (i.e., the base frame number for all DRX cycle lengths) is determined by the E-UTRAN.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for wireless communication in a wireless transmit receive unit (WTRU) comprising:
detecting a discontinuous reception (DRX) out of sync condition using a received DRX indicator, wherein the DRX indicator includes an IN-SYNC indicator; and
transmitting a sync request in response to the DRX out of sync condition.

2. The method of claim 1, wherein detecting the DRX out of sync includes determining if the IN-SYNC indicator in the DRX indicator matches an IN-SYNC indicator known by the WTRU.

3. The method of claim 2, wherein the received IN-SYNC indicator is an indicator value.

4. The method of claim 2, wherein the received IN-SYNC indicator is an indicator pattern.

5. The method of claim 1, wherein the DRX out of sync is detected when the WTRU does not receive the DRX indicator.

6. The method of claim 1, wherein the Sync Request is included in DRX
Indicator generated by the WTRU.

7. The method of claim 6, wherein the DRX Indicator generated by the WTRU further includes WTRU DRX parameters.

8. The method of claim 6, further comprising receiving selected DRX parameters in response to the Sync request.

9. The method of claim 8, wherein the selected DRX parameters are the WTRU DRX parameters.

10. The method of claim 8, wherein the selected DRX parameters are DRX parameters of an entity receiving the Sync request.

11. The method of claim 8, wherein the WTRU is reset to a continuous mode.

12. The method of claim 8, further comprising adjusting the WTRU DRX parameters to be equal to the received selected DRX parameters.

13. The method of claim 1, further comprising adjusting to DRX parameters included in the received DRX indicator.

14. The method of claim 1, wherein the sync request message includes suggested DRX parameters.

15. The method of claim 1, wherein the Sync Request is included in DRX Indicator generated by the WTRU.

16. The method of claim 6, wherein the DRX Indicator generated by the WTRU further includes WTRU DRX parameters.

17. The method of claim 6, further comprising receiving selected DRX parameters in response to the Sync request.

18. The method of claim 8, wherein the selected DRX parameters are the WTRU DRX parameters.

19. The method of claim 8, wherein the selected DRX parameters are DRX parameters of an entity receiving the Sync request.

20. The method of claim 5, further comprising switching to a shorter DRX cycle occasion to capture the DRX indicator when operating under a DRX long cycle.

21. The method of claim 5, further comprising receiving the DRX indicator over a wider range of frames when a DRX timing misalignment is detected.

22. The method of claim 5, further comprising trapping the DRX indicator by continuously receiving the DRX indicator over a certain number of frames, wherein a number of frames is greater than a DRX cycle length.

23. A method for wireless communication in a wireless transmit receive unit (WTRU) comprising:
transmitting a discontinuous reception (DRX) indicator including an In-sync indicator known to an entity receiving the DRX indicator;
receiving a sync request from the entity in response to the transmitted DRX indicator, the Sync request indicating a DRX out of sync condition; and
selecting DRX parameters for re-synchronizing the entity.

24. The method of claim 23, wherein the selecting includes:
determining whether to use entity DRX parameters, or WTRU DRX parameters.

25. The method of claim 23, wherein the sync request is included in a DRX indicator generated by the entity, wherein the DRX indicator further includes suggested DRX parameters.

26. The method of claim 25, further comprising adjusting WTRU DRX parameters to the entity suggested DRX parameters.

27. A wireless transmit receive unit (WTRU) comprising:
a processor for detecting a discontinuous reception (DRX) out of sync condition using a received DRX indicator, wherein the DRX indicator includes an IN-SYNC indicator; and
a transmitter for transmitting a sync request in response to the DRX out of sync condition.

28. The WTRU of claim 27, wherein detecting the DRX out of sync includes determining if the IN-SYNC indicator in the DRX indicator matches an IN-SYNC indicator known by the WTRU.

29. The WTRU of claim 28, wherein the received IN-SYNC indicator is an indicator value.

30. The WTRU of claim 28, wherein the received IN-SYNC indicator is an indicator pattern.

31. The WTRU of claim 27, wherein the DRX out of sync is detected when the WTRU does not receive the DRX indicator.

32. The WTRU of claim 27, wherein the Sync Request is included in DRX Indicator generated by the WTRU.

33. The WTRU of claim 32, wherein the DRX Indicator generated by the WTRU further includes WTRU DRX parameters.

34. The WTRU of claim 32, further comprising a receiver for receiving selected DRX parameters in response to the Sync request.

35. The WTRU of claim 32, wherein the selected DRX parameters are the WTRU DRX parameters.

36. The WTRU of claim 32, wherein the selected DRX parameters are DRX parameters of an entity receiving the Sync request.

37. The WTRU of claim 32, wherein the WTRU is reset to a continuous mode.

38. The WTRU of claim 32, further comprising adjusting the WTRU DRX parameters to be equal to the received selected DRX parameters.

39. The WTRU of claim 27, further comprising adjusting to DRX parameters included in the received DRX indicator.

40. The WTRU of claim 27, wherein the sync request message includes suggested DRX parameters.

41. The WTRU of claim 27, wherein the Sync Request is included in DRX Indicator generated by the WTRU.

42. The WTRU of claim 32, wherein the DRX Indicator generated by the WTRU further includes WTRU DRX parameters.

43. The WTRU of claim 32, further comprising receiving selected DRX parameters in response to the Sync request.

44. The WTRU of claim 34, wherein the selected DRX parameters are the WTRU DRX parameters.

45. The WTRU of claim 34, wherein the selected DRX parameters are DRX parameters of an entity receiving the Sync request.

46. The WTRU of claim 31, further comprising switching to a shorter DRX cycle occasion to capture the DRX indicator when operating under a DRX long cycle.

47. The WTRU of claim 31, further comprising receiving the DRX indicator over a wider range of frames when a DRX timing misalignment is detected.

48. The WTRU of claim 31, further comprising trapping the DRX indicator by continuously receiving the DRX indicator over a certain number of frames, wherein a number of frames is greater than a DRX cycle length.
